(19) United States
(12) Patent Application Publication
(10) Pub. No.: US 2009/0108019 A1
(43) Pub. Date: Apr. 30, 2009

(54) ICE CREAM PACKAGING

(76) Inventor: Gino Kronfle, Guayas (EC)

Correspondence Address: KEITH D. NOWAK, CARTER LEDYARD & MILBURN LLP, 2 WALL STREET, NEW YORK, NY, 10005, US

(21) Appl. No.: 11/928,809

(22) Filed: Oct. 30, 2007

(51) Int. Cl. B32B 15/08; B65B 11/00

(52) U.S. Cl. 221/199; 428/35.8

(57) ABSTRACT

The ice cream packaging of the present invention is a laminate thermal packaging capable of retaining cooler temperatures within the packaging for an extended period of time. Use of the packaging of the present invention, permits the ice cream to retain better physical, chemical and organoleptic properties. The packaging comprises layers of olefins, such as a polypropylene including a bi axially oriented polypropylene. One of the layers comprises a metallized bi axially oriented polypropylene containing aluminum. The present invention also provides a method of vending ice cream using the packaging of the present invention.

### FIELD OF THE INVENTION

The present invention relates to food packaging; specifically, to a food packaging having thermal properties suitable for retaining cooler temperatures within the packaging for extended periods of time.

### BACKGROUND OF THE INVENTION

Technological advancements in the area of food preservation have allowed consumers to extend the quality, life, and physical integrity of foods. Such technologies have also increased the ability of consumers to control when they consume food instead of forfeiting such control to the natural expiration of foods. One area that has been privy to technological advancements is the area of food packaging. Developments in food packaging have been aggressive, however modern packaging has provided limited advancements in the area of frozen novelties such as ice creams.

Frozen novelties such as bon bons, popsicles, ice cream sandwiches, etc. must be enjoyed immediately, once out of the freezer. Warm temperatures cause ice cream to melt, drip, and decrease in physical integrity rapidly. At present, ice cream packaging has not provided thermal properties that allow the retention of cool temperatures once outside a freezer setting for extended periods of time. An ice cream packaging is desired that preserves frozen novelties for an extended period of time once exposed to ambient environments. An ice cream packaging is also desired that would enable vendors to sell ice cream in a unique manner. Use of the present invention can serve to increase ice cream sales due to the retention of lower temperatures by the packaging and the influence of such lower temperatures on the ice cream's physical integrity for a longer period of time than is currently available.

### BRIEF SUMMARY OF THE INVENTION

The present invention is an ice cream packaging having thermal properties. The packaging is suitable for retaining cooler temperatures within the packaging for an extended period of time and maintaining the ice cream's physical integrity once exposed to the ambient environment. The packaging can be formed as a flexible laminate bag. The bag is comprised of layers of varied forms of polyolefins. The polyolefins can be transparent or metallized and may also be oriented. The present invention further envisions a method for vending ice cream products using the packaging of the present invention. The packaging retains cool temperatures for an extended period of time once outside the freezer. As a result, ice cream stored in the present packaging retains organoleptic properties and physical integrity for a period of time after exposure to ambient environment. Particularly, the flexible laminate packaging is useful for retaining and vending ice creams such as bon bons.

### BRIEF DESCRIPTION OF THE DRAWING

FIG. 1 is a graph showing the results of a comparative thawing test conducted on the packaging according to Example 1 of the present invention in comparison with the packaging according to Comparative Example 2 and Comparative Example 3.

### DETAILED DESCRIPTION OF THE INVENTION

The present invention is directed to a thermal packaging suitable for retaining frozen novelties. Once exposed to ambient temperatures, the packaging of the present invention retains cooler temperatures within the packaging for an extended period of time when compared to other packaging used to store ice cream. By retaining internal temperatures for an extended time period, the physical integrity of the ice cream is also maintained for a period of time that is longer than usual. The present invention is further directed to a method for packaging and vending such frozen novelties.

The packaging of the present invention is a laminate packaging made out of a plurality of layers. The various layers comprise polymeric material and metallized polymeric material. The term polymeric material refers to films made of durable synthetic polymers. The polymeric film may comprise materials such as polyolefins, polystyrenes, polyamides, polyesters, polycarbonates, polyvinyl alcohol, polyurethanes, polyacrylates including copolymers of olefins such as ethylene and propylene, ionomers, and mixtures thereof. Preferably, the polymer film comprises polyolefins. For example, polyolefins may include but are not limited to isotactic polypropylene, syndiotactic polypropylene, metallocene catalyzed isotactic polypropylene, metallocene catalyzed syndiotactic polypropylene, polypropylene (PP) such as oriented polypropylene, ethylene-propylene random copolymer, butene-propylene random copolymer, high density polyethylene, low density polyethylene, linear low density polyethylene and blends thereof.

Polyolefins of use in the present invention comprise polypropylene particularly oriented polypropylene being either uniaxially or biaxially oriented. The oriented film is stretched by conventional techniques such as tenter frame or a blown process. Stretching the film in one direction results in a uniaxially oriented film, while stretching the film in two directions, usually perpendicular directions, results in a biaxially oriented film. The preparation of oriented polypropylene is accomplished according to methods known in the art and is not within the scope of the present invention. The most preferred film used here is a biaxially oriented polypropylene (BOPP). The BOPP used here may be an isotactic polypropylene. The degree to which the film is stretched depends to some extent on the ultimate use for which the film is intended.

Metallization of the polymeric film layer is accomplished using techniques known in the art. For example, metallization may be accomplished by vaporizing a metal in a vacuum chamber under very high vacuum (a vacuum deposition process) in which the metal is evaporated to the film layer in a chamber maintained under conditions of high vacuum. Suitable metals for metallization include nickel, copper, silver, gold, titanium, vanadium, chromium, maganese, iron, cobalt, zinc, aluminum, or palladium, the preferred being aluminum. The vacuum coated film of use in the present invention is specifically a metallized, biaxially oriented polymeric film, preferably metallized biaxially oriented polypropylene containing aluminum.

Metallization of BOPP film by vacuum deposition of a very thin layer of aluminum provides excellent light, oxygen, and water vapor barrier properties. Metallized BOPP has many noted qualities such as strength, clarity, surface gloss, and barrier properties that hinder negative impact from light, moisture, and oxygen. Increased barrier properties reduce deterioration and enables increased shelf life of the product. The metallized layer may be prepared according to any method known in the art. Such preparation is not within the scope of this invention.

The layers of the packaging of the present invention include at least an outer layer, a core layer, and an inner layer. The core layer has a top side and a bottom side, wherein the outer layer is adjacent the top side of said core layer and the inner layer is adjacent the bottom side of the core layer. All layers are compressed together to form a laminate.

The layers are composed of an olefin, particularly a polypropylene, more specifically biaxially oriented polypropylene. The outer layer preferably comprises a transparent biaxially oriented polypropylene, the core layer preferably metallized biaxially oriented polypropylene, and the inner layer preferably transparent biaxially oriented polypropylene. The metallized biaxially oriented polypropylene of the core layer is preferably metallized with aluminum.

The thickness of each layer is about 40 microns to about 10 microns, specifically about 30 microns to about 15 microns. Preferably, each layer is 17 microns thick and weighs 15.5 gr/m². The packaging of the present invention has a total thickness of about 80 microns to about 20 microns, specifically, about 60 microns to about 30 microns, more specifically the packaging is 51 microns thick and weighs 36.5 gr/m².

The packaging film of the present invention complies with FDA regulations for food contact applications. The packaging is designed so the outer layer bears food grade printed indicia indicative of the product, for instance, a sales logo, a trademark, and a description of ingredients. The inner layer contacts the contents of the packaging. Accordingly, the laminate packaging of the present invention may take any form including a bag, a pouch, or a wrap. The packaging of the present invention may be displayed by hanging the thermal packaging from a hanger or standing it on a shelf. The packaging may be sold individually or as a unit when packaged in a box. Additionally the thermal packaging of the present invention may use an adhesive or any method known in the art for closing edges and other openings of the packaging closed. Exemplary dimensions of the bag include a width being about 4¾″ (120 mm+/−2 mm) and having a length of 7 1/16″ (180 mm+/−3 mm).

In a preferred embodiment, the packaging of the present invention is designed as a pouch for retaining and vending ice cream. In particular, the pouch embodiment provides a unique way by which vendors sell ice cream such as bon bons. Bon bons are cylindrical shaped ice cream covered in chocolate having a diameter ranging between 25 to 30 mm. The pouch retaining bon bons are stored in freezer like temperatures until sold either individually or as a packaged box unit. In either case, once the packaging is taken out of freezer-like temperatures, the packaging will dissipate cool temperatures from within the packaging at a slower rate or, stated differently, retain cooler temperatures within the packaging for a longer period of time when compared to other packaging. As a result of retaining cooler temperatures within the packaging for an extended period of time, the physical integrity of the bon bons are maintained for an equivalent period of time after being exposed to ambient temperatures.

The thermal properties of the packaging of the present invention have been unexpectedly found by the Applicant to provide better temperature retention and lower cold air dissipation when compared to other packaging. The example and comparative examples explain the present invention more particularly, but they do not limit the present invention.

### EXAMPLES

For the purpose of illustrating the present invention, tests were performed to evaluate how well the ice cream packaging retained temperatures within the packaging after being exposed to ambient temperatures. The data obtained was then compared to other ice cream packaging. Each test packaging was formed as a pouch and retained about the same number of bon bons. The internal temperature of each packaging s was recorded over time, averaged, and compared on a graph. In the following tests, the bon bons were first equalized to a temperature and then thawed for 30 minutes in an ambient environment. Temperatures within each packaging were monitored using individual temperature monitoring systems such as temperature logging devices. One such temperature logging device is a T-logger manufactured by 3M™. The T-logger is often used in the food industry to monitor temperature sensitive shipments. The T-logger is a miniaturized electronic device able to record and store temperatures over a period of time between temperatures ranging between −20 and 60° C.

### Example 1

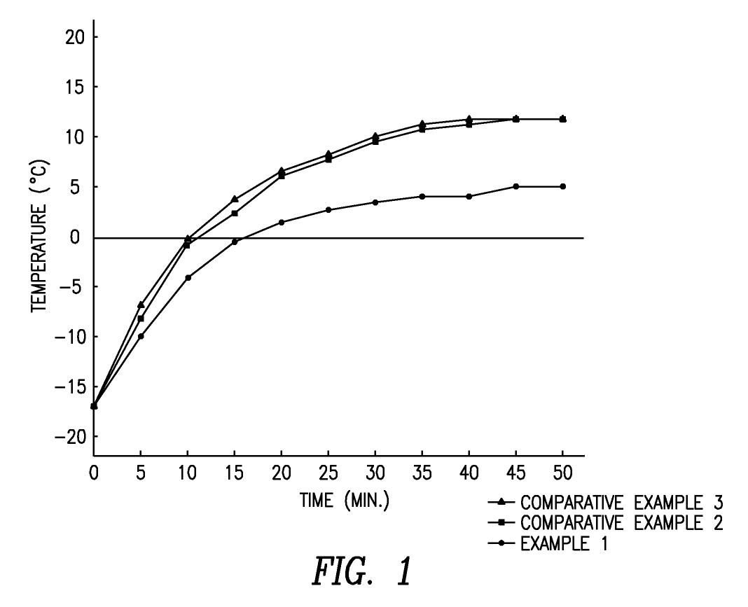

Six pouches of the present invention were stored in a hardening tunnel at a temperature of −42° C. for one hour in order to equalize temperature. Individual temperature monitoring systems, T-loggers, were introduced into each pouch after which each pouch was closed and repackaged in boxes containing 24 pouches each. The box was stored in a frozen storage room at −25° C. for 12 hours. Afterwards, the box was retrieved and the test pouches were extracted from the box. The pouches were left to thaw for 30 minutes in a controlled ambient environment of 20+/−2° C. After the thaw time of 30 minutes, the T-loggers were removed from the pouches and the data stored in the T-logger was discharged, averaged, and plotted. The results are shown in the graph of FIG. 1.

### Comparative Example 2

Example 1 was repeated except that a second packaging material was used. The second packaging material comprised a bi axially oriented pearl colored polypropylene bag. The bag comprised two layers of food grade material. One layer is a bi axially oriented pearl colored polypropylene having a thickness of 30 microns and a weight of 21 gr/m². The second layer is a bi axially oriented transparent polypropylene being 25 microns thick and weighing 22.8 gr/m². The packaging of Example 2 had a total weight of 43.8 gr/m² and total thickness of 55 microns. The results are shown in the graph of FIG. 1.

### Comparative Example 3

Example 1 was repeated except that a third packaging material was used. The third packaging material comprised one layer of food grade, bi axially oriented transparent polypropylene. The packaging was 25 microns thickness and weighed 22.8 gr/m². The results are shown in the graph of FIG. 1.

Time zero was set at −17° C.+/−−0.2° C. which was two minutes into the thawing process. Comparative examples 2 and 3 gained heat at a much accelerated rate as compared to the packaging of the present invention, example 1. For instance, a temperature differential of about 4° C. is exhibited at 15 minutes and 8° C. at 45 minutes between example 1 and comparative examples 2 and 3.

The packaging of Example 1 showed a differential of 33% better thermal properties at 15 minutes and 52% at 30 minutes as compared to the packaging of comparative Examples 2 and 3. The packaging of Example 1 shows retention of low temperatures for a longer period of time than the comparative examples. With a longer retention of cool temperatures over time, the ice cream stored in the packaging of the present invention has better physical, chemical, and organoleptic properties.

1. A thermal laminate packaging suitable for retaining cool temperatures within the packaging and maintaining product integrity comprising:
an outer layer, said outer layer being a bi axially oriented polypropylene; and
a core layer, said core layer being a metallized polypropylene, said core layer having a top side and a bottom side, said top side of said core layer being adjacent the outer layer.

2. The ice cream packaging of claim 1 further comprising an inner layer, said inner layer being a polypropylene, said inner layer being adjacent the bottom side of said core layer.

3. The packaging of claim 2, wherein the polypropylene of said inner layer is bi axially oriented polypropylene.

4. The packaging of claim 1, wherein said metallized polypropylene is bi axially oriented polypropylene containing aluminum.

5. The packaging of claim 1, wherein said outer layer is 17 microns thick, said core layer is 17 microns thick, thus providing a combined thickness of said outer layer and said inner layer of 34 microns.

6. The packaging of claim 2, wherein said inner layer has a thickness of 17 microns.

7. The packaging of claim 2 having a thickness of 51 microns.

8. An ice cream packaging retaining cool temperatures within the packaging for a period of time comprising:
an outer layer, said outer layer being a polypropylene;
a core layer, said core layer being a metallized bi axially oriented polypropylene, said core layer having a top side and a bottom side, said top side of said core layer being adjacent to the outer layer; and
an inner layer, said inner layer being a polypropylene, said inner layer being adjacent to the bottom side of said core layer.

9. The packaging of claim 8, wherein said outer layer is formed of a transparent bi axially oriented polypropylene and said inner layer is formed of a transparent bi axially oriented polypropylene.

10. The packaging of claim 8, wherein said metallized bi axially oriented polypropylene contains aluminum.

11. The packaging of claim 8, wherein said outer layer has a thickness of 17 microns, said core layer has a thickness of 17 microns, and said inner layer has a thickness of 17 microns.

12. The packaging of claim 8 having a thickness of 51 microns.

13. A method of vending an ice cream products comprising;
providing a thermal packaging for retaining ice cream, the thermal packaging capable of retaining temperatures within the packaging for an extended period of time, the packaging comprising an outer layer, said outer layer being a polypropylene, a core layer, said core layer being a metallized bi axially oriented polypropylene, said core layer having a top side and a bottom side, said top side of said core layer being adjacent to the outer layer, and an inner layer, said inner layer being a polypropylene, said inner layer being adjacent to the bottom side of said core layer;
inserting said ice cream product in the packaging;
sealing the packaging retaining the ice cream; and
displaying said packaging containing the ice cream for customer purchasing.

14. The method of 13 wherein said outer layer is transparent bi axially oriented polypropylene, the core layer is metallized bi axially oriented polypropylene containing aluminum, and the inner layer is a polypropylene.

15. The method of 14 wherein said polypropylene of said inner layer is transparent bi axially oriented polypropylene.

16. The method of 13 wherein said ice cream are bon bons.

17. The method of 13 wherein said packaging is about 51 microns thick.

18. The method of 13 wherein said outer layer has a thickness of 17 microns, said core layer has a thickness of 17 microns, and said inner layer has a thickness of 17 microns.

19. The method of 13 wherein the packaging is displayed individually for sale.

20. The method of 13 wherein the packaging is displayed as a packaged boxed unit for sale.
